(19) United States
(12) Patent Application Publication
(10) Pub. No.: US 2006/0152081 A1
(43) Pub. Date: Jul. 13, 2006

(54) Multi rubber band track system for a military tracked vehicle

(75) Inventors: Marc Delisle, Montreal (CA); Jean-Luke Noel, Shefford (CA)

Correspondence Address: GOUDREAU GAGE DUBUC, 800 PLACE VICTORIA, SUITE 3400, MONTREAL, QUEBEC, H4Z 1E9, CA

(73) Assignee: CAMOPLAST INC.

(21) Appl. No.: 11/366,522

(22) Filed: Mar. 3, 2006

(30) Foreign Application Priority Data
Apr. 11, 2005 (CA) 2,504,211

(51) Int. Cl. B62D 55/26

(52) U.S. Cl. 305/185

(57) ABSTRACT

A track system for a light to medium armored tracked vehicle comprising two independent rubber band tracks, one on each side of the vehicle.

### CROSS REFERENCE TO RELATED APPLICATIONS

This application claims priority on Canadian patent application no. 2,504,211, filed on Apr. 11, 2005. All documents above are herein incorporated by reference.

### FIELD OF THE INVENTION

The present invention relates to light single hull to medium armored tracked vehicles. More specifically, the present invention is concerned with a multi-track system military vehicle running on band tracks.

### BACKGROUND OF THE INVENTION

Light to medium armored tracked vehicles standardly use a two-traction system as shown in FIG. 1, which includes one track on each side of the vehicle, the tracks being tensioned around wheels or idlers.

Recently, rubber band tracks have been introduced to replace steel link tracks on such vehicles, for a number reasons including weight and noise reduction. Typically, this introduction has been more a substitution than an adaptation of the whole traction system to the rubber band track requirements. Consequently, these vehicles now suffer from an inadequate match between the previous steel link traction system and the new band track technology, which results, for example, in detracking, reliability and durability problems.

There is a need in the art for a traction system using rubber band tracks for light to medium armored tracked vehicles.

### SUMMARY OF THE INVENTION

More specifically, there is provided a traction system for light to medium armored tracked vehicles.

Other objects, advantages and features of the present invention will become more apparent upon reading of the following non-restrictive description of embodiments thereof, given by way of examples only with reference to the accompanying drawings.

### BRIEF DESCRIPTION OF THE DRAWINGS

In the appended drawings:

FIG. 1 illustrates a traction system as known in the art; and

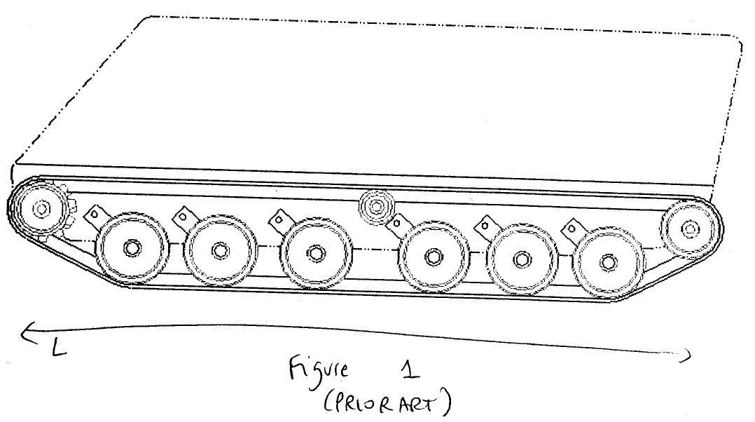

FIG. 2 illustrates a traction system according to an embodiment of the present invention;

FIG. 3 illustrates a traction system according to a further embodiment of the present invention; and

FIG. 4 illustrates a traction system according to still a further embodiment of the present invention.

### DESCRIPTION OF EMBODIMENTS OF THE INVENTION

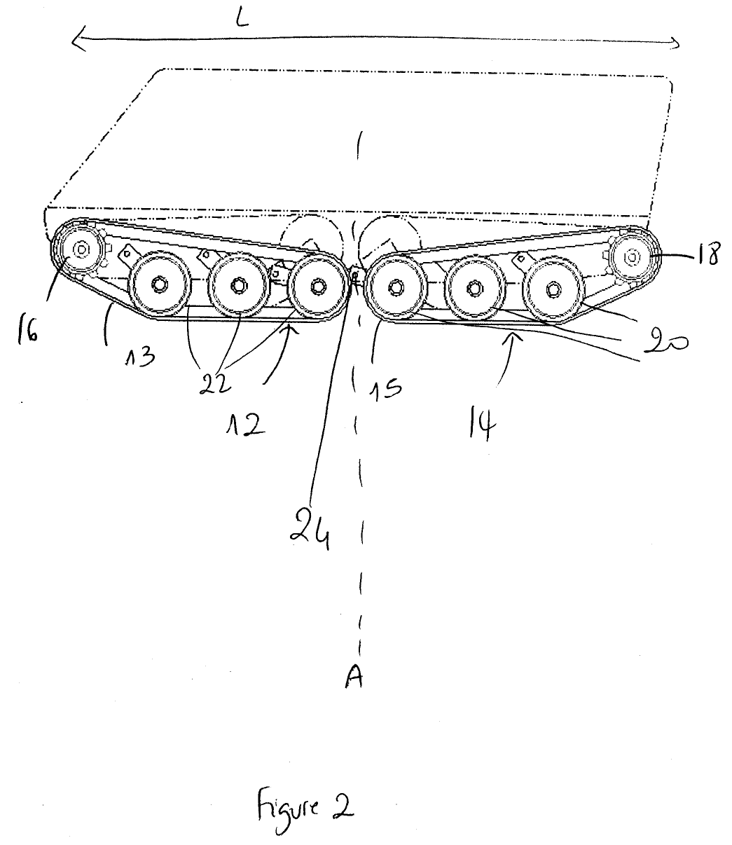

As illustrated in FIG. 2 of the appended drawings, a traction system for a light to medium armored tracked vehicle according to an embodiment of the present invention comprises two independent track systems 12, 14, one on each side of the vehicle.

Each track system 12, 14 comprises a rubber belt 13, 15 tensioned around drive sprockets 16 and 18 and roller wheels 20, 22 connected to a frame and integrating suspension elements, arranged in a substantially trapezoidal shape.

On each side of the vehicle, the track system 12, 14 are positioned in a mirror-like fashion on each side of a plane A, which allows an improved angle of departure, as shown in FIG. 2.

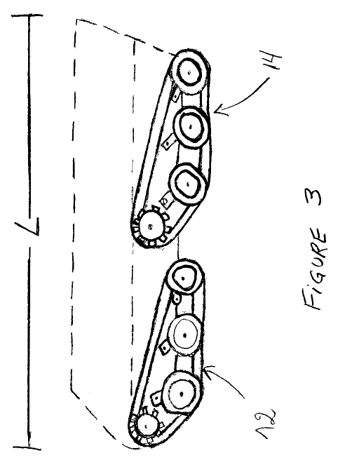

In another embodiment, illustrated in FIG. 3, the track systems 12 and 14, one on each side of the vehicle, are positioned so as to face a same direction in terms of angle of attack.

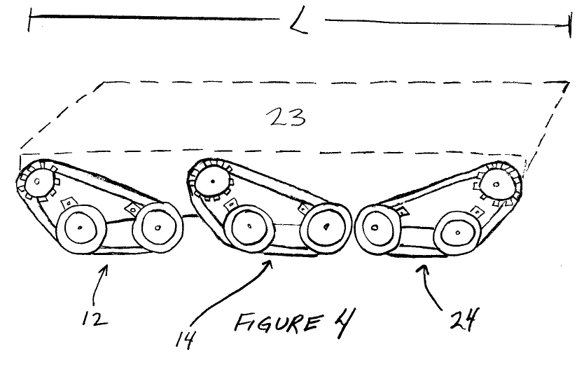

In still a further embodiment, illustrated in FIG. 4, each side of the vehicle is provided with three (or more) track systems 12, 14 and 24, two (or more) of the track systems 12 and 14 are positioned facing a same direction in terms of angle of attack of each track system, while the third (or more) track system 24 faces an opposite direction, which provides enhanced reliability and may be applied to larger vehicles.

The use of rubber band tracks allows a significant weight reduction over the use of steel link tracks, which may prove convenient as far as air transportability of the vehicles, as may be required in the cases of military operations for example.

The use of rubber band tracks further provides a significant reduction of noise over the use of steel link tracks, which may be critical in the military field.

The provision of more than one track system on each side of the vehicle allows the vehicle to travel at high speed with increased security by maintaining directionnal control of the vehicle at all time during the loss of one such track from unintentionnal causes.

It is further found that since each band track has a reduced length compared to the length L of the vehicle, the risks of detracking are significantly reduced compared to vehicles mounted on two-track traction systems (one-track system on each side).

Moreover, a vehicle provided with the present multi-track system is allowed increased mobility to return normally to a maintenance facility even with only three of the four band tracks running, for example, as a result of a track failure. People in the art will appreciate that such a feature translates into an increased survivability to mine blast explosions for such vehicles by way of redundancy.

The present invention therefore provides a traction system comprising multi-independent track systems, using for example four, six or more independent units, under a tracked vehicle. Each track system unit may be designed for light to medium armored military vehicle applications, fitted with rubber band tracks, i.e. for relatively high load and speed, heavy-duty applications where all-terrain mobility is required.

It has also been validated that a plurality of smaller, lighter tracks will lend themselves to easier installation and handling. The vehicle thus equipped can be balanced on one less track system than usual (i.e. 3 systems on a 4-system vehicle), while a damaged track is being replaced without external lifting means or help being required. Such smaller tracks can be carried on-board as spare much easier than a full size counterpart.

By way of construction, rubber band tracks do not achieve as much drawbar pull or braking efficiency as similar metal tracks due to less efficient torque transfer from sprocket to drive lugs. A multi-track system provides twice as many, or more, number of sprockets collectively transferring torque to the belt, minimizing ratcheting.

Although the present invention has been described hereinabove by way of embodiments thereof, it may be modified, without departing from the nature and teachings of the subject invention as defined in the appended claims.

What is claimed is:

1. A multi-rubber band track system for a tracked vehicle as described herein.

2. A military single hull tracked vehicle with a multi-independent track system as described herein.
